(19) United States
(12) Patent Application Publication
(10) Pub. No.: US 2010/0119293 A1
(43) Pub. Date: May 13, 2010

(54) DEVICE FOR CONNECTING MICRO-PUMPS TO BOTTLES

(75) Inventor: Marco Zavarella, Sulmona (IT)

Correspondence Address: YOUNG & THOMPSON, 209 Madison Street, Suite 500, Alexandria, VA, 22314, US

(73) Assignee: EMSAR S.P.A., San Giovanni Teatino (CH) (IT)

(21) Appl. No.: 12/597,708

(22) PCT Filed: Apr. 14, 2008
(86) PCT No.: PCT/IT2008/000246

§ 371 Date: Oct. 26, 2009

(30) Foreign Application Priority Data
Apr. 24, 2007 (IT) RM2007A000241

(51) Int. Cl. F16B 7/04; B23P 11/00

(52) U.S. Cl. 403/2; 29/525.01

(57) ABSTRACT

A device for connecting micro-pumps to bottles includes a ring nut (2) able to be associated to a micro-pump and engageable to a neck of a bottle, and a collar (8) connected to the ring nut (2) through one or more breakable connecting elements (9). The collar (8) is movable, as a result of the breakage of the connecting elements (9), from a non operative position to an operative position in which the collar (8) maintains the ring nut (2) engaged to the neck of the bottle.

### TECHNICAL FIELD

The present invention relates to a device for connecting micro-pumps to bottles.

In particular, the present invention relates to a system for fastening a micro-pump to a bottle containing fluid, liquid or viscous products, such as liquid soaps, lotions, perfumes, room fragrances, deodorants, pharmaceutical products or detergent products in general.

The micro-pump is put in fluid communication with the interior of the bottle and it must be fastened irremovably to the neck of the bottle.

Typically, the bottles to which the present invention applies present a standard fastening neck by seaming, i.e. having a constant inner diameter and an outer diameter that widens at the end of the bottle, thereby obtaining an outwardly projecting annular edge.

### BACKGROUND ART

In many known systems for connecting micro-pumps to bottles by seaming, metallic or plastic fastening components are used, having retaining portions which engage the projecting edge of the bottleneck.

The fastening components are generally ring nuts, used alone or coupled with other retaining elements, which present a plurality of internal shoulders and undercuts which, in fact, by interfering with the annular edge of the bottleneck, lock the ring nut to the neck of the container and consequently fasten the micro-pump to the bottle.

Fastening ring nuts can be, for example, of the snap-on type, characterised by a pre-shaped internal undercut profile, which has to be fit around the annular edge of the bottleneck, exerting a certain axial pressure and exploiting the elastic deformability of the component. The ring nut of the snap-on type is able by itself to keep the bottle sealed and assure high resistance against disassembly, thanks to the high radial load exerted on the bottleneck by the ring nut itself.

Alternatively, as disclosed in U.S. Pat. No. 4,773,553, the ring nut initially has no internal undercut but it is provided with a series of appendages that are deformed and rotated towards the bottleneck as a result of the fitting of an external collar. The deformation of the appendages that are engaged underneath the edge of the annular rim, and the simultaneous presence of the external collar assure the retention of the micro-pump to the bottle. This system is used for example when it is not possible, for reasons of structural strength of the bottle itself, to use snap-on ring nuts. The bottles can be made of plastic, glass or metal.

There are also types of snap-on ring nuts that still require also an external collar, to assure the solidity of the ring nut, because they exert, by themselves, a low radial load on the bottleneck. This is shown, for example, in the Patent EP 0707895 by the same Applicant. In this patent, the fastening element can be defined as a “hybrid” system, because, in addition to the ring nut, which presents pre-formed retaining elements, there is also an external collar that prevents the removal of the ring nut.

The elements for retaining the ring nut are present both on the inner surface of the ring nut to seam it to the bottleneck, and on the outer surface facing the collar, to assure the tightness of the outer collar on the ring nut itself.

The types described above, however, have some disadvantages. Snap-on ring nuts, i.e. those generally characterised by a single pre-formed plastic component, have limited possibility to modulate the load exerted on the bottleneck, having to assure a high resistance against disassembly and a high sealing ability only by means of undercuts of considerable size and ring nuts that are highly rigid and poorly deformable radially. This, in addition to complicating the assembly process and to prolong process times, limits the use of similar devices only to bottles able to withstand high radial and/or axial stresses.

In the case instead of systems provided both with the retention ring nut and the outer fastening collar, the greatest disadvantage is due to a structural complication due to the interaction of two different components that have to be assembled stable on each other, to assure the integrity of the artefact until its definitive application onto the final package.

In particular this drawback takes on more relevance in the case of pumps made entirely of plastic, where the additional fastening collar would not have the aesthetic value typically provided by metallic collars, and it would lead to an unjustified cost increase.

### DISCLOSURE OF INVENTION

An object of the present invention therefore is to overcome the aforementioned drawbacks.

In particular, an object of the present invention is to propose a device for fastening micro-pumps to bottles in which a single component is present, able to assure a stable assembly of the micro-pump to the bottle, without having high radial retaining loads and/or compressing axial loads acting on the bottle and without undesired releases of product outside the bottle itself.

A second object of the present invention is to propose a device for fastening micro-pumps to bottles usable with bottles of any material, and which therefore affords greater freedom in the use of glass bottles with smaller thickness valves, or of plastic bottles with lower axial strength. An additional object of the present invention is to propose a device for fastening micro-pumps to bottles that is adaptable to bottles having different axial dimensions of the neck, assuring better aesthetics of the packaging on different types of bottles.

Lastly, an object of the present invention is to propose a device for fastening micro-pumps to bottles that enables to assemble the micro-pump to the bottle simply and quickly, with a single fitting action.

These objects and others as well, which shall become more readily apparent in the course of the following description, are achieved by a device for fastening micro-pumps to bottles comprising the technical characteristics set out in one or more of the appended claims.

Additional characteristics and advantages shall become more readily apparent from the detailed description of a preferred, but not exclusive, embodiment of a device for fastening micro-pumps to bottles according to the present invention.

### DESCRIPTION OF THE DRAWINGS

The description shall be set out below with reference to the accompanying drawings, provided purely by way of non limiting indication, in which:

FIG. 1 shows a top view of a device for fastening micro-pumps to bottles of the present invention;

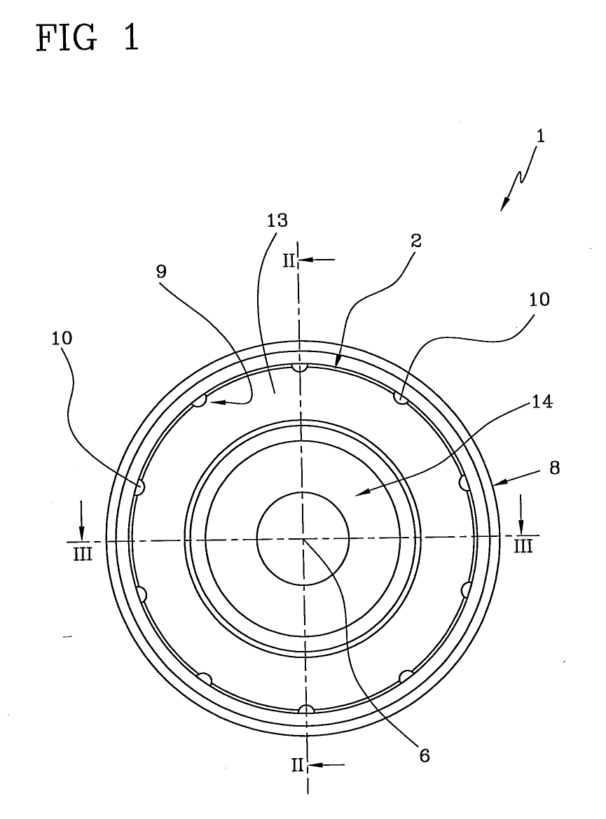

FIG. 2 shows a lateral sectioned view of the device of FIG. 1 according to the plan II-II;

FIG. 3 shows a lateral sectioned view of the device of FIG. 1 according to the plan III-III;

FIG. 4 shows a sectioned lateral view of the device of the present invention in assembled configuration.

### DESCRIPTION OF THE ILLUSTRATIVE EMBODIMENT

With reference to the aforementioned figures, the number 1 indicates, in its entirety, a device for fastening micro-pumps to bottles in accordance with the present invention.

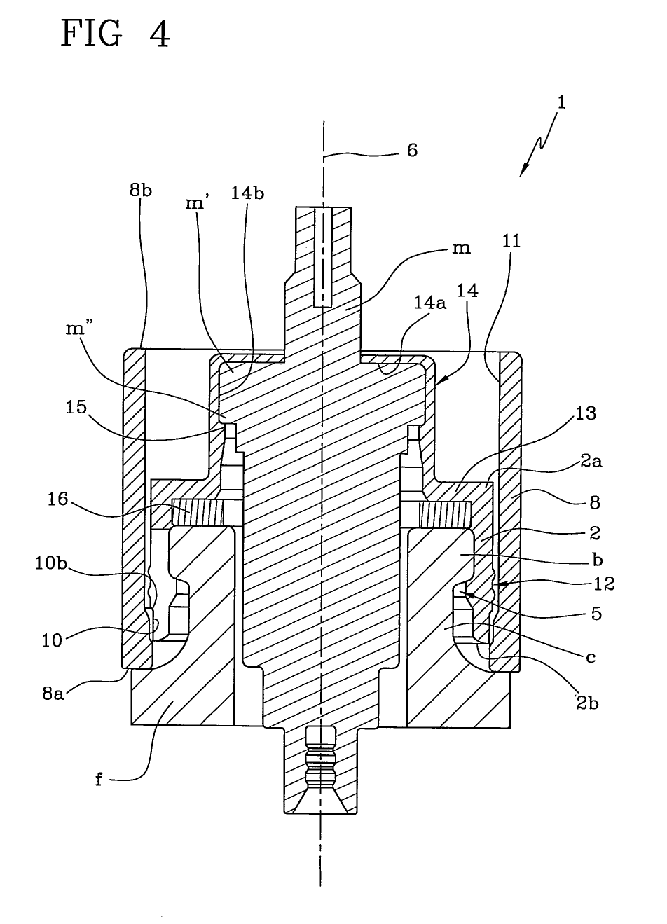

The bottles, whereon the device 1 can be mounted, preferably present a neck c (FIG. 4) having constant inner diameter and outer diameter that widens, in proximity to the mouth of the bottle f, towards the exterior of the bottle f itself, to form a projecting annular edge b.

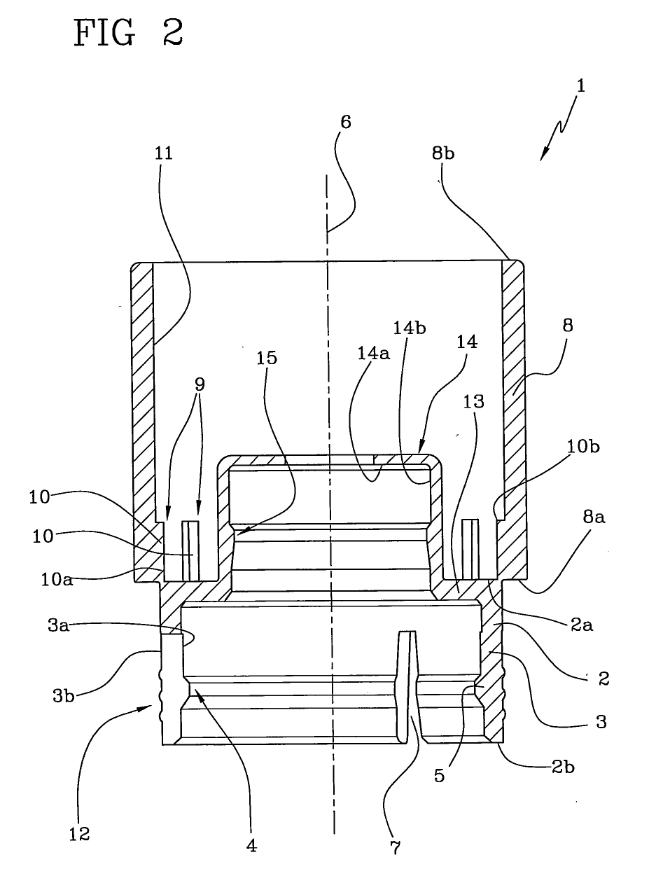

The device 1, as shown in FIGS. 2 and 4, comprises a ring nut 2, having substantially cylindrical shape, presenting a lateral wall 3 having an inner surface 3a and an outer surface 3b. The ring nut 2 is engageable by interference directly to the neck c of a bottle f by means of first retaining means 4 present on the inner surface 3a of the lateral wall of the ring nut 2.

In particular, said first retention means 4 comprise at least one undercut 5, projecting radially towards the interior of the ring nut 3, i.e. towards the central axis of symmetry 6 of the ring nut 2. The undercut 5 achieves a mechanical connection with the projecting annular edge b of the neck c of the bottle f, as shown in FIG. 4.

The fastening device 1 further comprises a collar 8, preferably coaxial to the ring nut 2. The collar 8 is integral with the ring nut 2 whereto it is connected, in a non operative position, by means of breakable connecting elements 9.

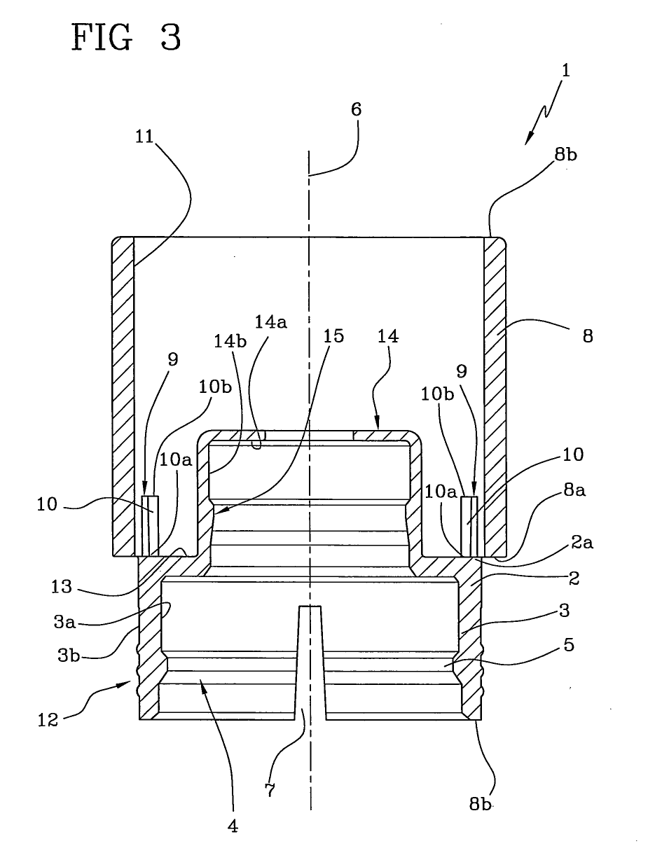

In greater detail, the breakable connecting elements 9 are preferably situated at a first end 8a of the collar 8 itself. As long as they remain intact, said connecting elements 9 connect the first end 8a of the collar 8 to a first end 2a of the ring nut, maintaining the collar 8 in a non operative position. In this non operative position, the collar 8 is aligned axially with the ring nut 2, at a different height from that of the ring nut 2, along the axis of symmetry 6. In other words, considering the device 1 associated to a bottle f, hence with the ring nut 2 connected to the neck c of the bottle f itself, the collar 8 is positioned above the ring nut 2 (FIGS. 2, 3). As a result of the breakage of the aforesaid connecting elements 9, the collar 8 is moved from the non operative position to an operative position, in which it is fitted around the ring nut 2.

In greater detail, applying an axial compression force on a second end 8b of the collar 8, axially opposite to the first end 8a, the connecting elements 9 break and the collar 8 assumes the aforesaid operative position.

In this latter operative position, the collar 8 is concentric to the ring nut 2 and encompasses it keeping it engaged to the neck c of the bottle f (FIG. 4). The inner diameter of the collar is substantially equal, except for any small play, to the outer diameter of the ring nut 2. In this way, when the collar 8 is fitted around the ring nut 2, it exercises a containment action on the ring nut itself which is added to the total compression radial load that the ring nut 2 itself exercises by itself on the neck c of the bottle f, preventing the removal of the device 1 and of the micro-pump associated therewith.

The axial force, applied on the second end 8b of the collar 8, causes the breakage by sliding of the breakable connecting elements 9.

Said breakable connecting elements 9 preferably comprise a plurality of discrete fastening areas. Each of these areas can be defined, in particular, by a respective axial rib 10, obtained on an inner lateral surface 11 of the collar 8.

Said ribs 10 project in radially internal direction, towards the central axis of symmetry 6 of the ring nut 3.

A first end 10a of said ribs 10, which connects the collar 8 to the ring nut 2 in the non operative position, is breakable as a result of the application of the aforesaid axial force.

The operative position of the collar 8 around the ring nut 2 is also maintained by the action of second retention means 12.

The aforementioned second retention means 12 preferably comprise one or more annular undercuts positioned circumferentially on the outer surface 3b of the lateral wall 3 of the ring nut 2.

Each of the ribs 10 presents a respective second end 10b having a sharp edge that engages, by interference, with the secondary retention means 12 and, specifically, with one of the undercuts present on the outer surface 3b of the ring nut 2. In this way, when the collar 8 is fitted around the ring nut 2, the undercut 12, underneath which is positioned the sharp edge of the second end 10b of the rib 10, contrasts the axial movement of the collar 8 and prevents the disengagement between collar 8 and ring nut 2. The axial sliding of the collar 8, in the displacement from the non operative position to the operative position, is limited by the very geometry of the bottle f which, typically, underneath the neck c, widens to define the region of containment of the liquid or, in other configurations of the system, by an appropriate end stop undercut internal to the collar.

Advantageously, the lateral wall 3 has at least one notch 7, preferably axial, developing from the second end 2b of the ring nut 2 at least partially along the height of the lateral wall 3. Preferably the ring nut 2 presents three notches 7, advantageously distanced from each other by 120°.

The notches 7 increase the radial deformability of the ring nut 2, to reduce the radial load exercised by the ring nut 2 itself on the neck c of the bottle f, during the step of fitting the ring nut 2 around the neck c.

At the first end 2a of the ring nut 2, there is a flange 13 that extends in radially internal direction, on a plane that is preferably substantially horizontal to the central axis of symmetry 6 of the ring nut 2. The flange 13 is able to overlie and to bear on an upper surface of the neck c of the bottle f.

The device 1 further comprises positioning means 14 associated with said flange 13, to maintain the micro-pump m in the correct position relative to the bottle f. Said positioning means 14 are preferably shaped as an upside down cup and they rise, from the flange 13, away from said ring nut 2. Advantageously, the positioning means 14 in the form of an upside down cup are centrally holed, for the insertion of the micro-pump m. A base surface 14a, of the positioning means 14, bears against a shoulder m′ of the micro-pump m, to keep it in position, in fluid connection with a liquid contained in bottle f (FIG. 4). On a lateral inner surface 14b of the positioning means 14 in the form of an upside down cup is present a mechanism 15 for connection to the micro-pump m. Preferably said connecting mechanism 15 is an undercut that interferes, circumferentially, with a lateral shoulder m″ of the micro-pump m.

Preferably, the device of the present invention is completely made of plastic, in particular by moulding.

Specifically, the presence of the ribs 10 has the further purpose of conveying the flow of material during the moulding operation.

To mount the micro-pump m on the bottle f, the following steps are performed.

The micro-pump m is inserted into the portion in the form of an upside-down cup 14, in such a way that the neck of the micro-pump m emerges from the portion 14.

The micro-pump m is then partially inserted into the bottle f. As a result of a slight axial pressure, which causes a corresponding radial deformation of the lateral wall 3 of the ring nut 2, the ring nut 2 is fitted on the neck c of the bottle f. Advantageously, it is possible to position a gasket 16 between the flange 13 and the upper surface of the neck c of the bottle f. At this point the ring nut 2 is correctly positioned on the neck c of the bottle f.

Subsequently, the connecting elements 9 have to be broken, to enable the displacement of the collar 8 from the non operative position to the operative position.

In particular, exerting on the collar 8 an axial compression force, greater than that applied to fit the ring nut on the bottleneck, the ribs 10 are broken and the collar 8 is positioned around the ring nut 2.

The collar 8 thus tightens the ring nut 2 around the neck c of the bottle f, maintaining the micro-pump m, in position, fastened to the bottle f and preventing its removal.

The ribs 10 have the dual purpose of compressing the lateral wall of the ring nut 2 against the neck c of the bottle f, in order to prevent the radial deformation of the ring nut in the external direction and to maintain the inner undercut 5 engaged below the projecting annular edge of the neck c, and to prevent the removal of the collar through the interference that is generated between the sharp edge of the second end 10b of the ribs 10 and the outer undercuts 12.

The presence of several undercuts 12, on the outer surface 3b of the ring nut 2, enables to adjust the positioning height of the collar 8 on the neck c of the bottle f, allowing a greater adaptability of the device as the axial dimension of the neck c of the bottle f varies, i.e. as the height of the shoulder of the bottle f varies relative to the mouth of the bottle f itself, always assuring a good aesthetic performance of the package on any type of bottle f.

With a single component it is therefore possible to assure a fast, practical and stable assembly of the micro-pump m to the bottle f without having high radial retention loads and/or axial compression loads acting on the neck c of the bottle. In this way it is possible to apply the device also to glass bottles with smaller thickness values, or to plastic bottles with less axial resistance, allowing a greater flexibility in the selection of the shapes and of the materials constituting the bottles.

The device is in any case able to exert such a force on the neck c of the bottle f as to seal the bottle f avoiding undesired releases of the product.

1. A device for connecting micro-pumps to bottles, comprising:
a ring nut (2) able to be associated to a micro-pump (m) and engageable to a neck (c) of a bottle (f);
a collar (8) associated to said ring nut (2);
characterised in that said collar (8) is connected to said ring nut (2) through one or more breakable connecting elements (9); said collar being displaceable, as a result of the breakage of said connecting elements (9), from a non operative position to an operative position in which the collar (8) maintains said ring nut (2) engaged to the neck (c) of the bottle (f).

2. Device as claimed in claim 1, characterised in that said ring nut (2) comprises first retaining means (4) presenting, preferably, at least one annular undercut (5), situated along an inner surface (3a) of said ring nut (2) and engageable by interference to the neck (c) of the bottle (f).

3. Device as claimed in claim 1, characterised in that said collar (8), in the non operative position, is axially aligned to said ring nut (2), whereto it is connected by means of said one or more breakable connecting elements (9), positioned at respective first ends (2a, 8a) of said collar (8) and of said ring nut (2).

4. Device as claimed in claim 3, characterised in that said collar (8), in the operative position, is fitted around said ring nut (2); said collar (8) passing from the non operative position to the operative position as a result of the breakage, by sliding, of said connecting elements (9) consequent to the application, on a second end (8b) of said collar (8) opposite to the first end (8a), of an axial compression force.

5. Device as claimed in claim 1, characterised in that it comprises second retaining means (12) to maintain said collar (8) in operative position around said ring nut (2).

6. Device as claimed in claim 5, characterised in that said second retaining means (12) comprise one or more annular undercuts situated on an outer surface (3b) of said ring nut (2).

7. Device as claimed in claim 1, characterised in that said breakable connecting elements (9) comprise a plurality of discrete fastening areas.

8. Device as claimed in claim 7, characterised in that said discrete connecting areas are defined by a plurality of axial ribs (10) obtained on an inner lateral surface (11) of said collar (8).

9. Device as claimed in claim 8, characterised in that said ribs (10) present a first breakable end (10a) which connects said collar (8) to said ring nut (2) when the collar (8) is in the non operative position.

10. Device as claimed in claim 9, further comprising second retaining means (12) to maintain said collar (8) in operative position around said ring nut (2), said second retaining means (12) comprising one or more annular undercuts situated on an outer surface (3b) of said ring nut (2), and said ribs (10) comprising a second end (10b) having a sharp edge that engage by interference one of the undercuts (12) present on the outer surface (3b) of said ring nut (2), to maintain the collar (8) in said operative position.

11. Device as claimed in claim 1, characterised in that said ring nut (2) comprises at least one notch (7), which extends from a second axial end (2b) of the ring nut (2), opposite to a first end (2a) whereat the ring nut (2) is connected to said collar (8), to increase the radial deformability of the ring nut (2).

12. Device as claimed in claim 1, characterised in that said ring nut (2) comprises, at a first end (2a), a flange (13) that extends in radially internal direction, able to bear against an upper surface of the neck (c) of the bottle (f).

13. Device as claimed in claim 12, characterised in that it further positioning means (14) associated with said flange (13), to maintain the micro-pump m in position, in fluid communication with a liquid contained within the bottle (f).

14. Device as claimed in claim 13, characterised in that said positioning means (14) comprise, on an inner lateral surface (14b), a connecting mechanism (15) with the micro-pump (m).

15. Device as claimed in claim 1, characterised in that it is made of plastic material, preferably by moulding.

16. Method for connecting a micro-pump (m) to a bottle (f) comprising the following steps:
preparing a connecting device (1) provided with a ring nut (2) and with a collar (8) connected to said ring nut (2) through one or more breakable connecting elements (9);
associating a micro-pump (m) to a bottle (f) through said ring nut (2), able to be associated to a neck (c) of said bottle (f);
breaking said connecting elements (9);
moving said collar (8) from a non operative position to an operative position in which it is fitted around said ring nut (2).

17. Method as claimed in claim 16, comprising the additional step of applying a first axial compression force to associate said ring nut (2) to the neck (c) of the bottle (f).

18. Method as claimed in claim 17, comprising the additional step of applying a second axial compression force, greater than the first force, on said collar (8), in such a way as to move the collar (8) from the non operative position to the operative position, as a result of the breakage of said connecting elements (9).

19. (canceled)

20. Device as claimed in claim 2, characterised in that said collar (8), in the non operative position, is axially aligned to said ring nut (2), whereto it is connected by means of said one or more breakable connecting elements (9), positioned at respective first ends (2a, 8a) of said collar (8) and of said ring nut (2).
